(19) United States
(12) Patent Application Publication
(10) Pub. No.: US 2002/0118825 A1
(43) Pub. Date: Aug. 29, 2002

(54) Headset with retractable microphone and speaker

(76) Inventor: Dan C. Mitra, Fort Lauderdale, FL (US)

Correspondence Address: LERNER AND GREENBERG, P.A., POST OFFICE BOX 2480, HOLLYWOOD, FL, 33022-2480, US

(21) Appl. No.: 09/795,092

(22) Filed: Feb. 28, 2001

(51) Int. Cl. H04M 1/00; H04M 9/00

(52) U.S. Cl. 379/430

(57) ABSTRACT

A headset includes a base connected to a wireless telephone, a clip connected to the base, a microphone connected to the base, and an earplug connected to the base. A headset wire connects to the base and to the telephone. The headset wire is releasable from the base. A rotatable microphone stem connects the base and the microphone. A rotatable speaker stem connects the base and the speaker. A switch on the base opens and closes a circuit in the telephone. A speaker gear in the base connects to said speaker stem. A speaker gear in the base connects to the speaker stem, the speaker gear connects to the microphone gear. A cogwheel intermeshes between the speaker gear and the microphone gear. The microphone gear and the speaker gear are sized so that said speaker is moved to a deployed position when said microphone is moved to a deployed position and said speaker is moved to a retracted position when said microphone is moved to a retracted position. A switch in the base opens and closes a circuit in the telephone; the switch opens the circuit when the microphone and the speaker are in the deployed position, and the switch closes the circuit when the microphone and the speaker are in the retracted position. The clip attaches to a stem of a pair of eyeglasses worn by a caller.

### BACKGROUND OF THE INVENTION

1. Field of the Invention

The invention relates to headsets working with wireless telephones, and, in particular, to a compact headset that attaches to eyeglasses with a deployable microphone and earpiece.

2.Description of the Related Art

Wireless telephones have become so convenient and inexpensive that almost everyone owns one and uses it regularly. One of the most common places to use a wireless telephone is while driving an automobile. However, holding a wireless telephone to one's head while driving can be dangerous, especially in manual shifting cars.

Another problem with wireless telephones is that many users fear that electromagnetic fields produced by transmitter, receiver, and other components of the wireless telephone may cause cancer, especially brain tumors, when held close to the caller for extended periods of time.

Attempts to solve these problems include speaker telephones and headset units.

Existing headset units connect to a socket provided on the wireless telephone. The headset is a wire ending in one end with a plug fitting into the wireless telephone socket and the other end is an earplug that fits in the caller's ear. Along the wire, a microphone is placed that is approximately near the caller's mouth. A switch for answering and hanging up the wireless telephone can be added along the wire. Because the earplug blocks ambient sounds when inserted in the caller's ear, most callers remove the plug when they are not making a call. However, when an incoming call arrives and the earplug is not worn, the caller fumbles, looking for the headset. An improved headset adds a clip to the wire. The clip holds the headset in a place where the caller can locate it: for example, on the caller's shirt. Another problem is that the microphone does not hang directly in front of the caller's mouth. For this reason, a non-directional microphone is used. This microphone often picks up unwanted ambient noise.

An alternative headpiece is formed with a wire having one end connecting to the socket of the wireless telephone and the other end terminating in a microphone. Along the wire, an earplug is added. The problem with headsets of this type is that the microphone remains awkwardly placed before the caller's mouth even when not in use.

### SUMMARY OF THE INVENTION

It is accordingly an object of the invention to provide a headset that overcomes the above-mentioned disadvantages of the heretofore-known devices and methods of this general type, which is conveniently stored and easily deployed upon receiving or placing a call. The headset can attach to an electronic communication device such as a wireless telephone or portable two-way radio.

With the foregoing and other objects in view there is provided, in accordance with the invention, a headset including a base, a microphone, a speaker, and a clip. The base connects to a telephone. The clip connects to the base. The microphone and speaker connect to the base.

In accordance with another feature of the invention, the headset includes a headset wire to the telephone connected to the base. The headset wire can be detachable from the base. By being detachable, the headset wire can detach from the base (rather than rip from the base) in case the headset wire becomes snagged or the telephone drops. The headset wire also allows the wireless telephone to be placed remotely from the caller's head. Because, the strength of an electromagnetic field and other radiation produced by a wireless phone decreases with distance, the headset can minimize the exposure to a caller's head.

In accordance with another feature of the invention, the speaker is an earplug.

In accordance with another feature of the invention, the headset includes a microphone stem connecting the base and the microphone. The microphone stem can be rotatable about the base. By being rotatable, the microphone attached to the microphone stem can be positioned before a caller's mouth for clear recording of the caller's voice.

In accordance with another feature of the invention, the headset includes a speaker stem connecting the base and the speaker. The speaker stem can be rotatable about the base. By being rotatable, the speaker attached to the speaker stem can be positioned before a caller's ear for clear reproduction of the caller's voice.

In accordance with another feature of the invention, the headset includes a switch on the base opening and closing a circuit in the telephone for answering and placing calls.

In accordance with another feature of the invention, the headset includes a microphone stem connecting the base and the microphone, a speaker stem connecting the base and the speaker, a speaker gear in the base connected to the speaker stem, and a speaker gear in the base connected to the speaker stem. The speaker gear intermeshes with and mutually drives the microphone gear. In this way, when the speaker gear turns, so does the microphone gear.

In accordance with another feature of the invention, the headset includes a cogwheel connected to the speaker gear and the microphone gear.

In accordance with another feature of the invention, the microphone gear and the speaker gear are sized so that the speaker is moved to an on position when the microphone is moved to an on position and the speaker is moved to an off position when the microphone is moved to an off position.

In accordance with another feature of the invention, the headset includes a switch in the base opening and closing a circuit in the telephone. The switch opens the circuit when the microphone and the speaker are in the on position, and the switch closes the circuit when the microphone and the speaker are in the off position.

In accordance with another feature of the invention, the clip attaches to a stem of a pair of eyeglasses worn by a caller.

Other features that are considered as characteristic for the invention are set forth in the appended claims.

Although the invention is illustrated and described herein as embodied in a headset, it is nevertheless not intended to be limited to the details shown, because various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a front view of a headset connected to a wireless telephone;

FIG. 2 is a front view of the headset in the off position;

FIG. 3 is a front view of the headset in the on position;

FIG. 4 is a exploded view of the headset;

FIG. 5 is a top view of the headset;

FIG. 6 is a bottom view of the headset;

FIG. 7 is a right side view of the headset;

FIG. 8 is a left side view of the headset;

FIG. 9 is a front view of the headset;

FIG. 10 is a rear view of the headset;

FIG. 11 is a right side cutaway view of the headset;

FIG. 12 is a left side cutaway view of the headset;

FIG. 13 is a rear cutaway view of the headset;

FIG. 14 is a rear cutaway view of the headset;

FIG. 15 is a rear cutaway view of the headset;

FIG. 16 is a rear cutaway view of the headset;

FIG. 17 is a right side view of a second embodiment of a headset;

FIG. 18 is a right side view of the second embodiment when retracted;

FIG. 19 is a right side view of the second embodiment when deployed; and

FIG. 20 is a top view of the second embodiment.

### DESCRIPTION OF THE PREFERRED EMBODIMENTS

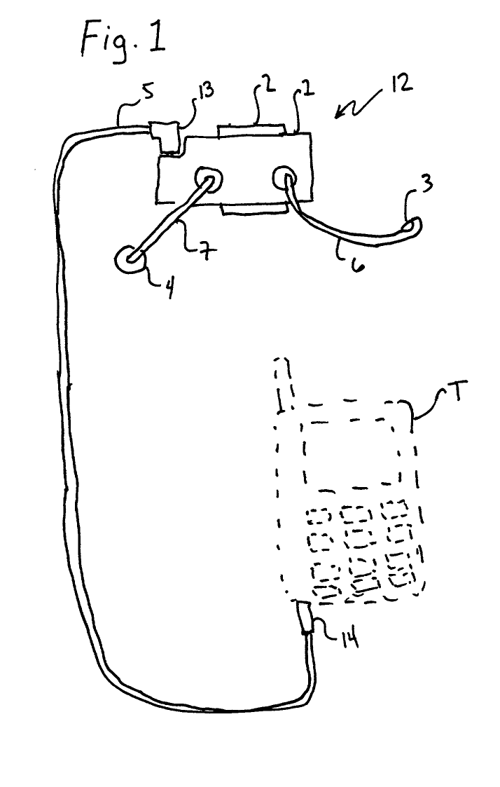

Referring now to the figures of the drawing in detail and first, particularly, to FIG. 1 thereof, there is seen a headset generally marked with reference number 12. The headset 12 includes a base 1. The base 1 is connected to a wireless telephone T by a headset wire 5. The headset wire 5 has two ends. The first end of the headset wire ending in a headset plug 13 the other end of the headset wire 5 ending with a telephone plug 14. The headset plug 13 detaches from the base 1 and prevents the headset from being permanently damaged if the headset wire 5 is accidentally pulled.

A microphone 3 receives sounds from the caller. The microphone is connected to the base 1. Sounds recorded by the microphone 3 are carried from the microphone 3 through the base 1 and headset wire 5 to the wireless telephone T for transmission.

The microphone 3 is placed at the end of a microphone stem 6. The microphone stem 6 places the microphone in front of the caller's mouth for optimal recordation of the caller's voice. The microphone stem 6 connects to the base 1 and houses a microphone wire 15 running from the microphone 3 to the headset wire 5.

A speaker 4 preferably in the form of an earplug plays received sounds electronically transmitted from the telephone T. The speaker 4 is located at the end of the speaker stem 7. The speaker stem 7 connects to the base 1 and houses a speaker wire 16 running from the speaker 4 to the headset wire 5.

As shown in FIG. 4, the microphone stem 6 connects to the microphone gear 9. The microphone gear 9 is mounted in the base 1 and can rotate therein. The microphone stem 6 can rotate on the microphone gear 9.

FIG. 4 also shows the speaker stem 7 connecting to the speaker gear 10. The speaker gear 10 is mounted in the base 1 and can rotate therein. The speaker stem 7 rotates on the speaker gear 10.

While the microphone gear 9 and the speaker gear 10 can intermesh and rotate each other directly or with any number of intermediate gears, the preferred embodiment includes a cogwheel 11 located between and intermeshing with both the microphone gear 9 and the speaker gear 10. By connecting the microphone gear 9 and the speaker gear 10 with the cogwheel 11, when the microphone stem 6 is rotated, the motion is translated to the speaker stem 7. The converse is also true; when the speaker stem 7 is rotated, the microphone stem 6 is turned.

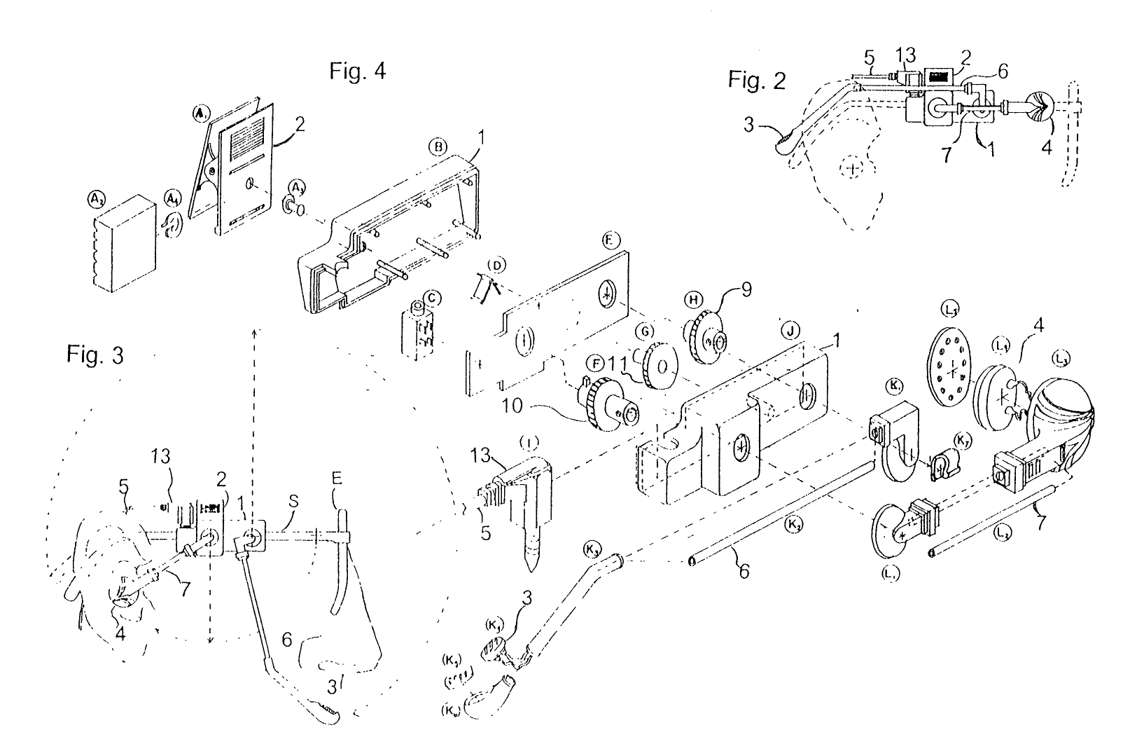

FIG. 2 shows a preferred embodiment of the headset in which the microphone stem 6 and speaker stem 7 are retracted. In this position, the speaker stem 7 has been rotated counter clockwise so that the speaker stem 7 extends forward and horizontally from the speaker gear 10. In addition, the microphone stem 6 has been rotated counter clockwise so that the microphone stem 6 extends rearward and horizontally from the microphone gear 9. In the retracted position, the wearer's speech, vision, and hearing are not obstructed because the microphone stem 6 has been moved away from the wearer's mouth and eyes and the speaker stem 7 has been moved away from the wearer's ear.

FIG. 3 shows a preferred embodiment of the headset in which the microphone stem 7 is deployed. In this position, the speaker stem 7 has rotated clockwise from the retracted position (see FIG. 2) so that the speaker in the form of an earplug 4 is plugged into the ear of the wearer. For most wearers, the deployed position of the speaker stem 7 angles the speaker stem downwardly and rearwardly from the speaker gear 10. In its deployed position, the microphone stem 6 has rotated clockwise from the retracted position (see FIG. 2) to a position where the microphone 3 is placed before the wearer's mouth. For most wearers, this position is downward and slightly forward from the microphone gear 9.

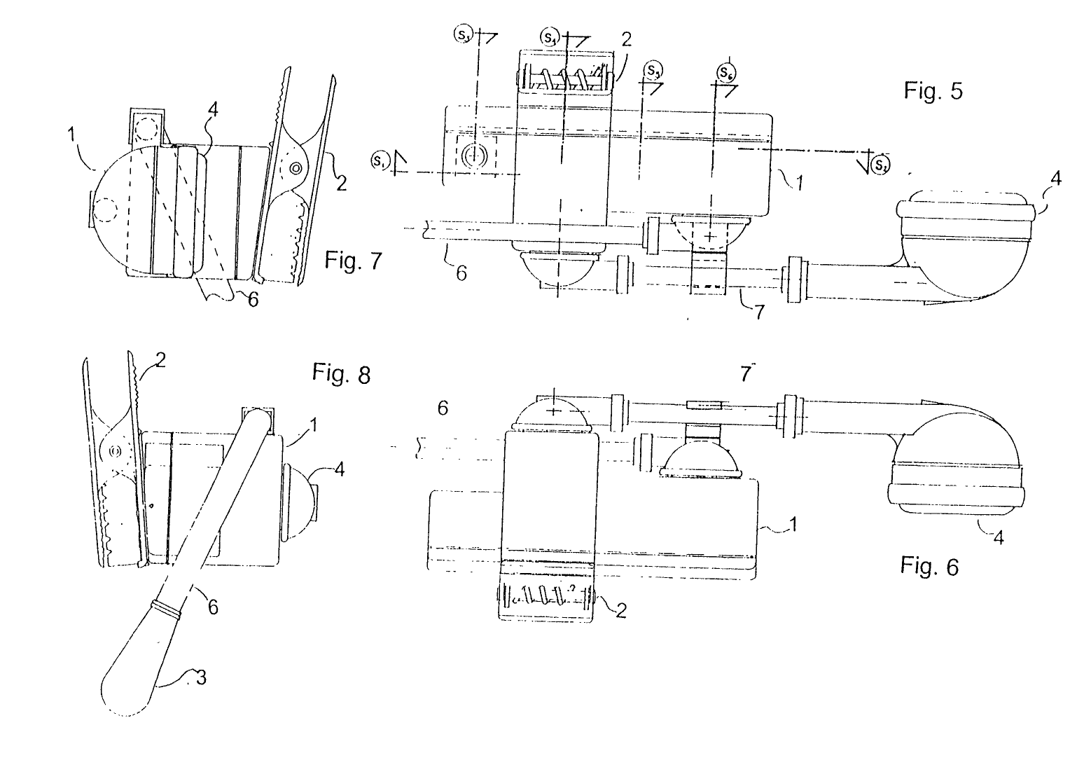

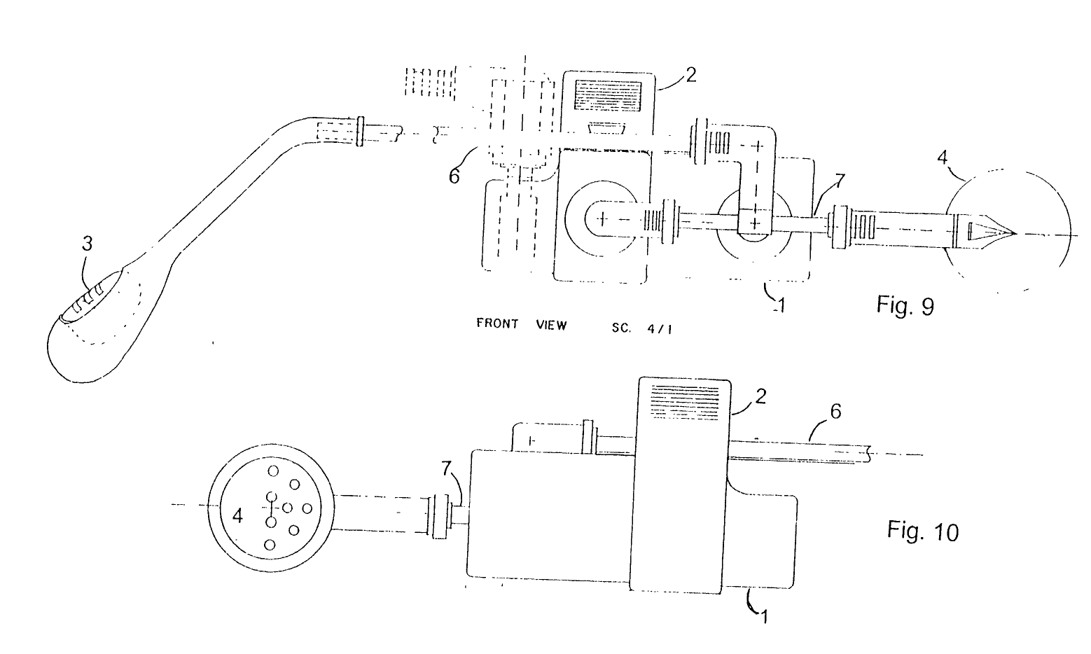

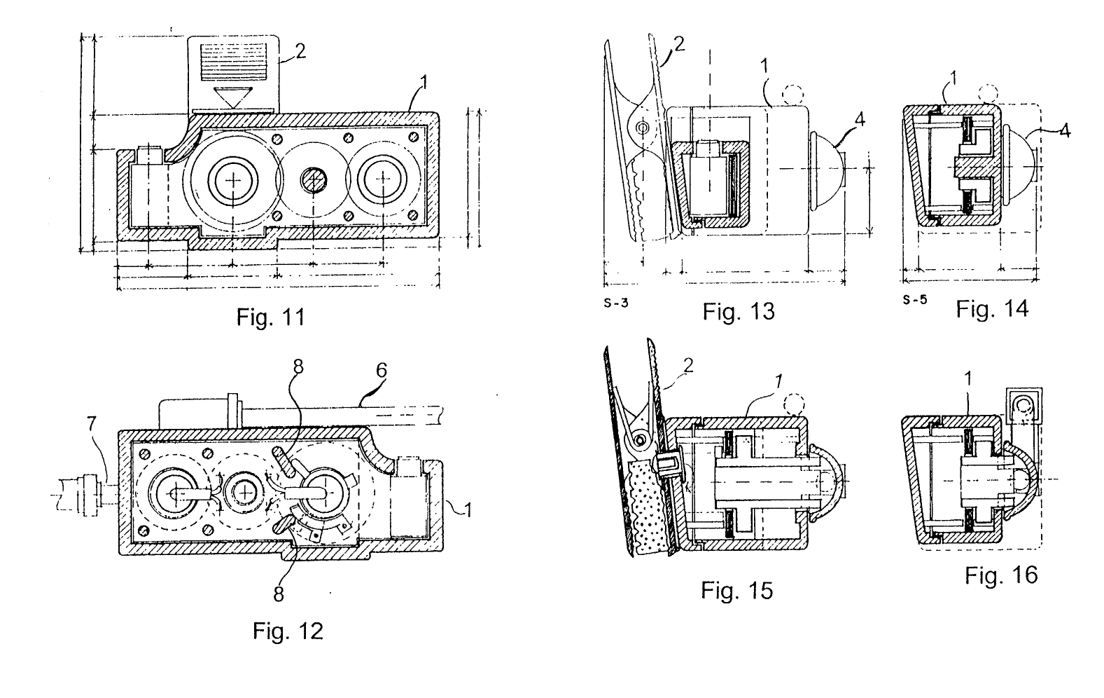

As shown in FIGS. 2-8, the headset includes an attachment connected to the base 1. Preferably, the attachment is a clip 2 on the base 1. However, the attachment includes elastic bands and other holders. The clip 2 attaches to an object on the wearer. Most preferably, the object is the stem S of a pair of eyeglasses E worn by the wearer. The object also can be a hat or headband. The clip 2 can be moved forward or backward along the stem S so that the speaker 4 is placed over the ear of the wearer. The clip 2 includes two sockets 17 and 18 that mate and are releasably held by pawls 19 and 20. When mated, the pawls 19 and 20 tend to hold the clip 2 to the base 1 and tend to prevent the clip 2 from rotating relative to the base 1.

In an embodiment of the invention, eyeglasses E are added to the headset. The eyeglasses have a stem S. The attachment 2 connects the base 1 to the eyeglasses E.

In a preferred embodiment, the microphone gear 9, speaker gear 10, and cogwheel 11 are sized with respect to each other so that when the microphone stem 6 is moved to the deployed position, the speaker stem 7 is also moved to the deployed position. At the same time, the microphone gear 9, speaker gear 10, and cogwheel 11 also should be sized so that, when the microphone stem 6 is moved to the retracted position, the speaker stem 7 is also moved to the retracted position. By joining the gears and correctly sizing them, the microphone 3 and the speaker 4 both can be positioned with a single motion.

The headset also can incorporate a switch 8. The switch 8 connects and disconnects calls made by the telephone T. In a preferred embodiment, the switch 8 is a contact in the base 1 that is activated connected when the microphone stem 6 and speaker stem 7 are deployed and this is disconnected when the microphone stem 6 and the speaker stem 7 are retracted.

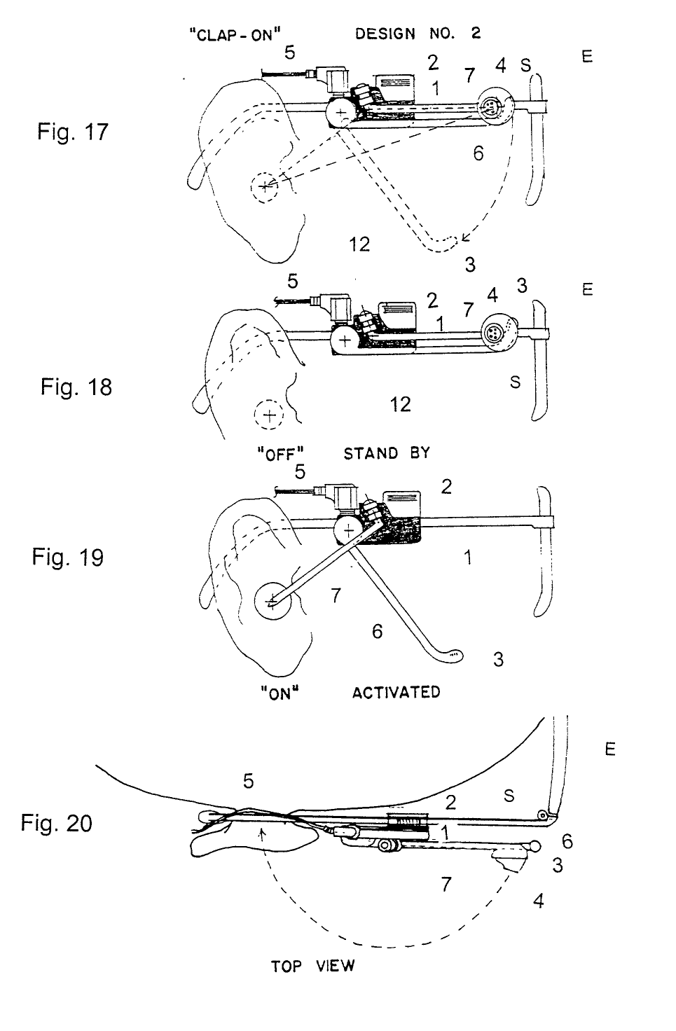

FIGS. 17-20 show a second embodiment of the invention. Again the headset 12 is attached to a pair of eyeglasses E by a clip 2. A speaker 4 having a speaker stem 7 is rotatably attached to a base 1. A microphone 3 having a microphone stem 8 is rotatably attached to the base 1.

As shown in FIGS. 17 and 20, upon receiving a call, the speaker 4 in the form of an earplug is rotated to the deployed position shown in FIG. 19. As the speaker 4 is deployed, the microphone stem 6 is released and drops into the deployed position shown in FIG. 19. When the call is complete, the microphone stem 6 is lifted to its retracted position (see FIG. 18) and the speaker stem 7 is locked in its retracted position.

I claim:

1. A headset comprising:
a base connected to a telephone;
an attachment connected to said base;
a microphone connected to said base; and
a speaker connected to said base.

2. The headset according to claim 1, including a headset wire connected to said base and to the telephone.

3. The headset according to claim 2, wherein said telephone is a wireless telephone.

4. The headset according to claim 1, wherein said speaker is an earplug.

5. The headset according to claim 1, including a microphone stem connecting said base and said microphone.

6. The headset according to claim 5, wherein said microphone stem is rotatable about said base.

7. The headset according to claim 1, including a speaker stem connecting said base and said speaker.

8. The headset according to claim 7, wherein said speaker stem is rotatable about said base.

9. The headset according to claim 1, including a switch on said base, said switch opening and closing a circuit in the telephone.

10. The headset according to claim 1, including:
a microphone stem connecting said base and said microphone;
a speaker stem connecting said base and said speaker;
a speaker gear in said base connected to said speaker stem;
a speaker gear in said base connected to said speaker stem, said speaker gear connected to said microphone gear.

11. The headset according to claim 10, including a cogwheel intermeshed between said speaker gear and said microphone gear.

12. The headset according to claim 10, wherein said microphone gear and said speaker gear are sized so that said speaker is moved to a deployed position when said microphone is moved to a deployed position and said speaker is moved to a retracted position when said microphone is moved to a retracted position.

13. The headset according to claim 12, further comprising:
a switch in said base opening and closing a circuit in the telephone, said switch opening the circuit when said microphone and said speaker are in the deployed position, and said switch closing the circuit when said microphone and said speaker are in the retracted position.

14. The headset according to claim 1, wherein said attachment is a clip.

15. The headset according to claim 14, wherein said clip attaches to a stem of a pair of eyeglasses worn by a caller.

16. The headset according to claim 1, including a pair of eyeglasses having a stem, said stem connecting to said attachment.

17. The headset according to claim 14, wherein said clip connects directly to said base.

18. The headset according to claim 17, wherein said clip rotates on said base.

19. The headset according to claim 2, wherein said headset wire is releasable from said base.
